(19) United States
(12) Patent Application Publication
(10) Pub. No.: US 2008/0067265 A1
(43) Pub. Date: Mar. 20, 2008

(54) Nozzle Comprising a Swirl Chamber

(76) Inventors: Jean-Pierre Songbe, Saint Pierre En Val (FR); Herve Imenez, Saint Valery Sur Somme (FR)

Correspondence Address: ST. ONGE STEWARD JOHNSTON & REENS, LLC, 986 BEDFORD STREET, STAMFORD, CT, 06905-5619, US

(21) Appl. No.: 11/940,580

(22) Filed: Nov. 15, 2007

Related U.S. Application Data
(63) Continuation of application No. PCT/FR06/00981, filed on May 2, 2006.

(30) Foreign Application Priority Data
May 18, 2005 (FR) 0551291

(51) Int. Cl. B05B 1/34

(52) U.S. Cl. 239/468; 239/463

(57) ABSTRACT

The invention relates to a fluid spray nozzle comprising a swirl chamber which is rotationally symmetric about a Z axis of origin O and into which at least two fluid inlet channels open. The aforementioned chamber is equipped with a discharge conduit having an axis which is inclined in relation to the axis of symmetry t an angle. According to the invention, the conduit is formed such that the position of the point of origin of the axis thereof is offset in relation the origin of the axis of symmetry by a distance which depends on the value of the angle of inclination of the conduit: along a direction which depends on the position and the cross-section of the channels, and in a sense which is counter to the orientation of the conduit.

### CROSS-REFERENCE TO RELATED APPLICATIONS

The present application is a continuation of pending International patent application PCT/FR06/000981 filed on May 2, 2006 which designates the United States and claims priority from French patent application 0551291 filed on May 18, 2005, the content of which is incorporated herein by reference.

### FIELD OF THE INVENTION

The present invention relates to a spray nozzle with a swirl chamber, designed for a spraying push button with a lateral outlet.

It relates, in particular, to a nozzle that ensures better spraying compared with current swirl chambers.

### BACKGROUND OF THE INVENTION

French patent application FR 2,853,635 describes a spraying push button with lateral outlet, comprising a swirl chamber with symmetrical rotation around a first axis, which has a central outlet and a peripheral inlet, and which is arranged between two moulded parts that are overall coaxial, an inner part and an outer part respectively, fitted into one another.

An impression that delimits a cavity forming said swirl chamber is made inside the outer part, the latter also comprising an ejection conduit which opens into the cavity on one side and onto the outside of the push button on the other side, extending through its wall from the centre of said impression.

The two parts comprise faces tilted in relation to a second axis of insertion which they share, being applied against one another. The impression is made on the tilted face of the outer part, and the tilted faces are arranged in a direction and according to an angle that is sufficient to allow the outer part to be removed from its mould along the shared axis (second axis of insertion) without damaging the impression.

The liquid to be sprayed enters the swirl chamber at a given rate by at least two inlet channels which open tangentially into the chamber.

In the usual manner, the rate at which the liquid is injected into the chamber generates an accelerated swirling rotational circulation of the liquid inside the chamber immediately before its ejection to the outside of the push button, causing the liquid to be sprayed.

The conduit of the swirl chambers is generally central with an axis matching the axis of symmetry of rotation of the chamber.

According to the embodiment of the push button described in patent application FR 2,853,635, the ejection conduit of the swirl chamber extends perpendicular to the shared axis of the two parts, in order to allow lateral spraying. Also, the axis of the ejection conduit is tilted in relation to the axis of the swirl chamber.

This tilt of the axis of the ejection conduit in relation to the axis of the swirl chamber disrupts and inhibits the effect produced by the swirl chamber, this effect being behind the spraying of the liquid at the outlet of the push button.

Indeed, the tilt of the axis of the ejection conduit creates a disturbance which unbalances the movement of the liquid injected in the swirl chamber at high speed. This movement is slowed down, weakened and even completely stopped at the inlet of the ejection conduit, which results in a jet being obtained at the outlet of the conduit as opposed to the desired spray.

A jet is obtained instead of a spray for the following reasons: the liquid swirls according to a movement with axial symmetry, and this movement is obtained in the swirl chamber around the central axis of the chamber. This movement of the liquid in accelerated rotation is greatly disrupted when it approaches the ejection conduit, due to the sudden change of direction caused by the tilted orientation of the ejection conduit in relation to the axis of the chamber.

In practice, for an ejection conduit tilted at a relatively low angle (of the order to 5° to 10°) in relation to the axis of the chamber, the obtained spray is degraded, uneven, and the flow is sprayed in a half-circle shape. And the higher the tilting angle, the lower the quality of the spray, until the spray becomes a jet almost in a straight line.

Also, in the context of the embodiment of the invention described in patent application FR 2,853,635, to rebalance the movement of the liquid inside the chamber, a structural unbalance was sought in terms of the liquid injection rate in the chamber. With this aim, the two inlet channels were made with different cross-sections.

However, such a solution does not make it possible to achieve the excellent spraying results obtained with a traditional swirl chamber with symmetry of rotation, with a central conduit sharing its axis with the chamber and with inlet channels having identical cross-sections.

### SUMMARY OF THE INVENTION

The present invention aims to avoid this problem of poor spraying quality caused by the tilt of the axis of the ejection chamber in relation to the axis of the swirl chamber, by providing a solution different to that consisting of making two channels with different cross-sections.

The present invention relates to a nozzle for spraying a liquid comprising a swirl chamber with symmetry of rotation around an axis Z with origin O, which at least two liquid inlet channels open into. The chamber includes an ejection conduit having its axis tilted in relation to the axis of symmetry of the chamber according to a certain angle. According to the invention, the conduit 4 is made so that its axis A has an origin O′

where the position is offset by a certain distance in relation to the origin O of the axis of symmetry of the chamber, the distance depending on the value of the tilting angle of the conduit in relation to the axis of the chamber;

according to a direction that depends on the position and the cross-section of the channels, and

according to a direction that is opposite to the orientation of the conduit.

Orientation of the conduit shall be understood to refer to the direction of ejection of the liquid from inside the chamber to the outside of the spraying nozzle.

It is possible, by offsetting the origin of the axis of the ejection conduit in relation to the origin of the axis of the chamber, to avoid the problem of disrupting the liquid swirling in the chamber.

Indeed, the swirling flow around the axis of symmetry of the chamber is broken down in the ejection conduit due to a change of direction.

By placing the inlet of the ejection conduit closer to one of the inlet channels of the chamber, an asymmetrical swirling flow is obtained in relation to the axis of the chamber.

However, this flow is always symmetrical in relation to a given axis.

It is therefore convenient to align the axis of the conduit with this axis, so that the swirling flow is symmetrical to the axis of the ejection conduit.

The solution consisting of offsetting the origin of the conduit in relation to the origin of the chamber therefore makes it possible to obtain a swirling flow that is symmetrical in relation to the axis of the ejection conduit. Indeed, when the tilted conduit is positioned in line with the axis of the chamber, the swirling flow is symmetrical in the chamber but completely asymmetrical in the ejection conduit. To obtain uniform spraying, it is necessary for the flow to be symmetrical in the ejection conduit. And it is possible, by offsetting the origin of the ejection conduit in relation to the origin of the axis of the chamber, to obtain a symmetrical swirling flow in the conduit.

According to a first embodiment of the nozzle according to the invention, for a tilting angle value of more than 20°, the distance separating the two origins O and O′ is at least equal to 60 μm, and preferably greater than or equal to 120 μm.

According to an alternative embodiment, for a tilting angle value of 60°, the distance separating the two origins O and O′ is 150 μm.

According to another embodiment of the invention, the channels open uniformly into the periphery of the chamber.

According to yet another embodiment of the invention, the channels have the same cross-section.

According to a further embodiment of the invention, the channels are positioned in a tangential direction in relation to the periphery of said chamber.

According to yet another embodiment of the invention, the channels have a curved and convex shape.

According to a further embodiment, the chamber is made up of a tapered cavity with a flat bottom which the upstream end of said conduit opens into.

The nozzle according to the invention therefore makes it possible to obtain uniform spraying, with chambers connected to channels in which the axis is tilted in relation to the axis of the chamber, so as to be capable of being implemented in push buttons designed for lateral spraying of liquids.

### BRIEF DESCRIPTION OF THE DRAWINGS

Further objectives and advantages of the invention will become apparent from the following description made in reference to the appended drawings, wherein:

FIG. 1 is a diagrammatic representation of a nozzle according to the invention in a profile view, in an XYZ frame of reference; and

FIG. 2 is another diagrammatic representation of the nozzle shown in FIG. 1, in a profile view, in an XY frame of reference.

### DETAILED DESCRIPTION OF THE INVENTION

The following description relates to an embodiment of a nozzle according to the invention which is particularly well adapted to a push button designed to deliver a liquid laterally in the form of a spray, as described in French patent application FR 2,853,635.

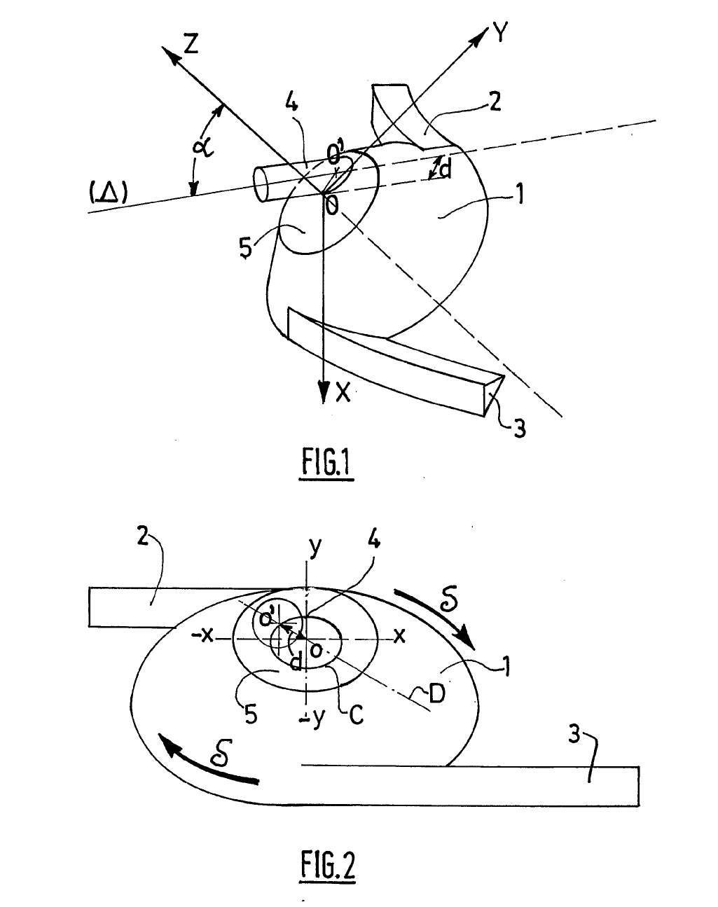

As shown in FIG. 1, the nozzle comprises a swirl chamber 1 with symmetry of rotation around an axis Z with origin O.

Two liquid inlet channels 2 and 3 open into this chamber 1.

However, the principle of the invention also applies to a nozzle equipped with more than two inlet channels.

As can be seen in FIGS. 1 and 2, the channels 2 and 3 have the same cross-section, so that the two channels have identical liquid flow-rate capacities.

Moreover, the channels 2 and 3 open uniformly into the periphery of the chamber 1. This promotes a uniform distribution of the liquid in the chamber.

To generate the swirling movement of the liquid in the chamber, it is foreseeable to position the channels 2 and 3 in a direction that is tangential to the periphery of the chamber 1, as shown in FIG. 2.

In order further to improve the swirling movement, it is also foreseeable to provide channels with a curved and convex shape. This embodiment of the invention is suggested in FIG. 1.

The chamber 1 is made up of a tapered cavity with a flat bottom 5 which the upstream end of a conduit 4 for ejecting the liquid to the outside of the nozzle opens into.

The ejection conduit 4 consists of a tubular element, and has an axis Δ which is tilted at an angle α in relation to the axis of symmetry Z of the chamber 1.

According to the invention, the conduit 4 is made so that its axis Δ has an origin O′ with a position offset by a distance d in relation to the origin O of the axis of symmetry Z.

The distance d depends on the value of the tilting angle α of the conduit.

According to the invention, the direction defined by the straight line connecting the two origins O and O′ depends on the position and cross-section of the channels 2 and 3 and, finally, the orientation direction between O and O′ is opposite to the orientation of the conduit 4, which is to say to the direction in which the liquid is ejected from the spraying nozzle.

Indeed, as mentioned previously, the disruption of the swirling flow created in the chamber increases at the inlet of the ejection conduit in line with the tilting angle of the conduit. Also, it has been found that the greater the tilting angle, the more important it becomes to increase the unbalance in the chamber in order to obtain uniform spraying at the outlet of the ejection conduit. Also, by placing the upstream orifice of the ejection conduit nearer the outlet end of one of the channels 2 or 3, the disruption caused by the tilt of the ejection conduit is compensated by the unbalance created by placing the inlet of the conduit nearer the outlet of one of the channels.

Moreover, as regards the direction of the straight line joining O and O′, it depends on the flow rate of the liquid introduced in the chamber and on the swirling movement that it generates in the chamber. As regards the vector direction from O to O′, it is advisable to place O′ in a direction opposite to the orientation of the conduit.

According to the invention, as shown in FIG. 1, for an angle value of more than 20°, the distance d is at least equal to 60 μm.

In the context of the depicted embodiment of the invention, it is provided for the tilting angle α of the conduit to be 60°. The distance d between O and O′ is substantially 150 μm (±20 μm).

Once the distance d has been determined, it is understood that the point O′ can be chosen from a circle C with a distance d with its origin as O.

As can be understood from FIG. 2, the point O′ is chosen on a straight line D with a direction substantially parallel to the tangent of the swirling flow passing through the point O. The direction of the swirling flow of the liquid in the chamber is symbolised by the arrows S in FIG. 2.

This straight line D passing through O cuts the circle C in two points.

The point O′ is chosen from between these two points so that the vector OO′ is in the opposite direction to the circulation direction of the flow (flow direction symbolised by the arrows S) and, in particular, to the direction of ejection of the product from the chamber via the conduit.

The preceding description clearly explains how the solution of the invention makes it possible to obtain uniform spraying.

The values given for angle α and distance d in the context of the example of an embodiment do not limit the invention in any way.

The invention extends to any nozzle that has the specific characteristics of the invention or equivalent means.

1. Nozzle for spraying a liquid comprising a swirl chamber with symmetry of rotation around an axis with origin, which at least two inlet channels for said liquid open into, said chamber being equipped with an ejection conduit, having its axis tilted in relation to the axis of symmetry by an angle, characterised in that said conduit is made so that its axis has an origin with a position offset by a distance in relation to the origin of the axis of symmetry which depends on the value of the tilting angle of the conduit;
according to a direction that depends on the position and the cross-section of said channels, and
according to a direction that is opposite to the orientation of said conduit.

2. Nozzle according to claim 1, characterised in that, for an angle value greater than 20°, the distance is at least equal to 60 μm, and preferably greater than 120 μm.

3. Nozzle according to claim 1, characterised in that, for an angle value of 60°, the distance is substantially 150 μm.

4. Nozzle according to claim 1, characterised in that said channels open uniformly into the periphery of the chamber.

5. Nozzle according to claim 1, characterised in that said channels have the same cross-section.

6. Nozzle according to claim 1, characterised in that said channels are positioned in a direction that is tangential to the periphery of said chamber.

7. Nozzle according to claim 1, characterised in that said channels have a curved and convex shape.

8. Nozzle according to claim 1, characterised in that said chamber is made up of a tapered cavity with a flat bottom which the upstream end of said conduit opens into.
